(19) United States
(12) Patent Application Publication
(10) Pub. No.: US 2006/0028830 A1
(43) Pub. Date: Feb. 9, 2006

(54) Automobile compound waterproof tail light

(76) Inventor: Kevin Tsai, Tainan (TW)

Correspondence Address: J.C. Patents, Suite 250, 4 Venture, Irvine, CA, 92618, US

(21) Appl. No.: 10/912,622

(22) Filed: Aug. 4, 2004

(51) Int. Cl. F21V 1/00

(52) U.S. Cl. 362/509

(57) ABSTRACT

An automobile compound waterproof taillight includes a bottom base, a main light base, a side light base and a sealing cap. A main light set, a license plate light set, a side light set, and a car width indicating light set are all arranged in the bottom base and separated with caps from one another to clearly show which light is used. The interior of the bottom base is filled with waterproof glue to keep all components therein sealed to keep them from getting wet so as to prolong its service life.

### BACKGROUND OF THE INVENTION

1. Field of the Invention

This invention relates to an automobile compound water-proof tail light, particularly to one provided with LED lamps for various light sources combined in a single case and positioned at the tail of an automobile or a tug boat, and kept in a stable water proof condition, and each light source clearly separated from one another for easy discernment.

2. Description of the Prior Art

Conventional automobile compound waterproof tail lights are generally provided with incandescent lights as light sources for indicating a tail light, a brake light, a direction changing light, a side indicating light, a car width indicating light and a license plate light. The compound waterproof taillight is provided with waterproof covers, rubber gaskets for preventing water from flowing or seeping in its interior. But they are liable to get damaged in its seal by high temperature, or rainfall. When they are used in a tugboat, they may often emerge in seawater, with high temperature suddenly dipped in very cold seawater to worsen its seal to let water flowing or seeping in.

A Sealed Tail Light for a Boat Trailer exposed in a U.S. Pat. No. 5,060,121 enclosed in this description makes use of traditional incandescent lights as light sources, and having a base 11 and a capsule 8 are boned together by glue or welded by a supersonic wave machine for sealing a light bulb 9 and a light bulb 10 in its interior for preventing water or moist from flowing or seeping in. However, traditional incandescent lights consumes much electricity, do not endure long, and generates high temperature but weak light beam, hardly meeting safety demand of recent traffic conditions. Moreover, the main light, the side indicating light and a license plate light are not clearly separated so it is quite confusing to discern what it really indicates.

### SUMAMRY OF THE INVENTION

The purpose of the invention is to offer an automobile compound waterproof taillight possible to separately indicating various functions of lights and making use of LED lights consuming low power, sealed with waterproof glue, and having a long service life.

One of the feature of the invention is a bottom base of an opaque case-like shape, having a front side closed with a main light cap colored and transparent, a left side closed with a side light cap colored and transparent, an upper side closed with a car width indicating light cap, and a bottom side provided with a center opening closed with a license plate indicating light cap.

A second feature of the invention is a main light base opaque, fixed in the bottom base, having a case body, and a fix base extending from the case body for a side light base to fix on. Further, a first electric circuit board, a main light set facing the main light cap, a license plate light set facing the license plate light cap and closed with a lamp cover are all fixed in the case body. A separating plate is provided to separate the license plate light set from the main light set, and waterproof glue is poured in the case body to seal the first electric circuit board, the main light set and the license plate light set and the lamp cover together as integral.

A third feature of the invention is an opaque side light base fixed on the fix base, which has a second electric circuit board, a car width indicating light set facing the license plate light cap and a side indicating light set. A separating plate is provided to separate the car width indicating light set from the side indicating light set and the main light set. Further, waterproof glue is poured in the side light base to seal the second electric circuit board, the car width indicating light set and the side indicating light set together as integral.

A fourth feature of the invention is the transparent sealing cap closing on the case body of the main light base, having an extended portion for covering the side light base.

### BRIEF DESCRIPTION OF DRAWINGS

This invention will be better understood by referring to the accompanying drawings, wherein:

FIG. 1 is an exploded perspective view of an automobile compound waterproof taillight in the present invention;

FIG. 2 is a front view of the automobile compound waterproof taillight in the present invention;

FIG. 3 is a rear view of the automobile compound waterproof taillight in the present invention;

FIG. 4 is a perspective view of a main light base combined with a side light base in the present invention;

FIG. 5 is another perspective view of the main light base combined with the side light base in the present invention;

FIG. 6 is a perspective view of the main light base covered with a cap in the present invention;

FIG. 7 is a perspective and part of the inner condition exposed view of the main light base covered with the cap in the present invention;

FIG. 8 is a front view of the main light base, the cap and the bottom base combined together in the present invention;

FIG. 9 is a partial cross-sectional view of the compound waterproof taillight in the present invention;

FIG. 10 is an exploded perspective view of the bottom base and the main light cap in the present invention;

FIG. 11 is a perspective view of the compound waterproof taillight in a being used condition in the present invention; and,

FIG. 12 is a perspective view of the automobile compound waterproof taillight in the present invention.

### DETAILED DESCRIPTION OF THE PREFERRED EMBODIMENT

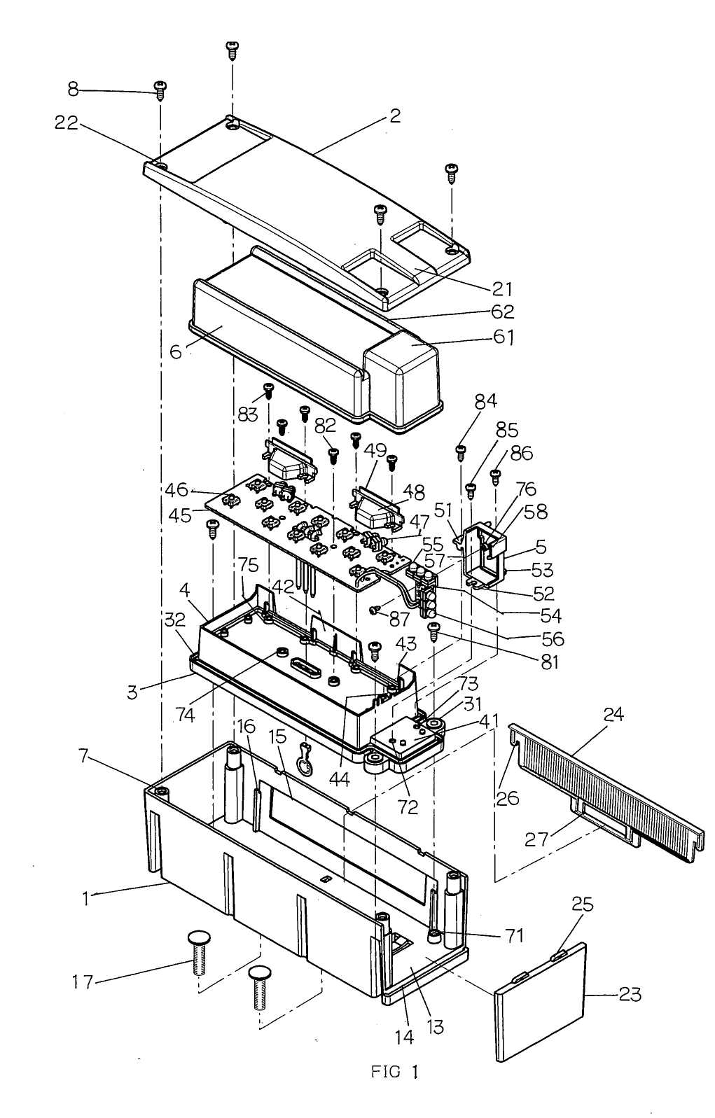

A preferred embodiment of an automobile compound waterproof taillight in the present invention, as shown in FIG. 1, includes a bottom base 1, a main light cap 2, a main light base 3, a side light base 5 and a sealing cap 6.

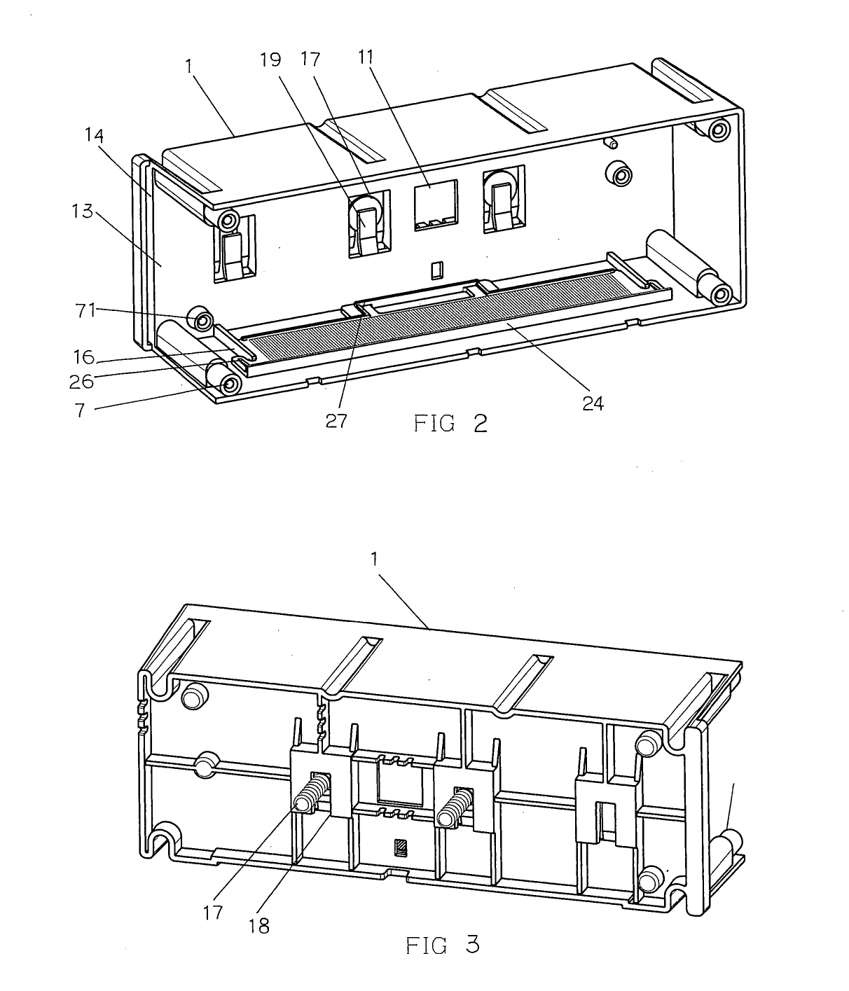

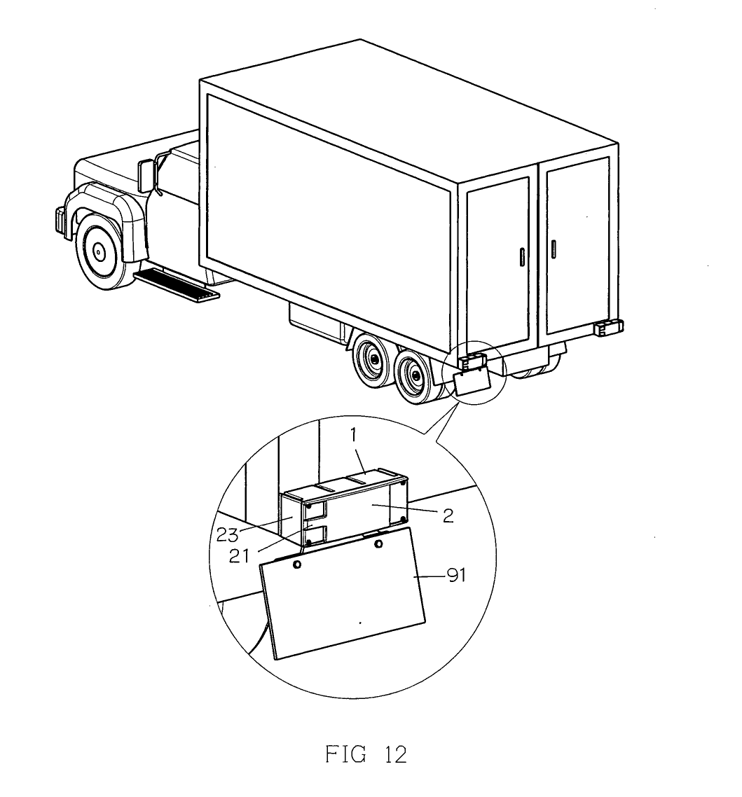

The bottom base 1, as shown in FIGS. 1, 2, 3, 11 and 12, is an opaque plastic case-like body, having a bolt 17 fitted in a rear wall and extending vertically down to reach above a license plate 18 fixed in a license plate frame 9. Further, the head of the bolt 17 remains at an upper surface of a sandwich groove plate 18 and pressed by a pressing plate 19, and the shank of the bolt 17 extends through the sandwich slot in the sandwich slot plate 18 fixed on an outer side wall of the bottom base 1. The bottom base 1 has a front opening 12 closed by a main light cap 2 of a curved-out colored transparent shape and provided with plural holes 22 to align to threaded holes 7 of the bottom base 1 for bolts 8 to pass through and screwed with the threaded holes 7. A car width indicating light cap 21 is positioned beside the main light cap 2, The bottom base 1 further has a groove 14 beside the left side opening 13 for a colored transparent side light cap 23 to close up. The side light cap 23 has two front projections, with the main light cap 2 covering on to keep the side light cap 23 in place. The bottom base 1 further has a center opening 15 in the bottom wall, two pairs of insert grooves 16 at two sides of the center opening 16 for two hooks 26 of a transparent license plate light cap 24 to hook with and keep the license plate light cap 24 stably in the center opening 15. The license plate light cap 24 further has a press strip 27 on an inner lower side. The side light cap 23 is vertical to the main light cap 2, and the license plate light cap 24 is vertical to the main light cap 2 and the side light cap 23. The bottom base 1 contains the main light base 3 and the sealing cap 6.

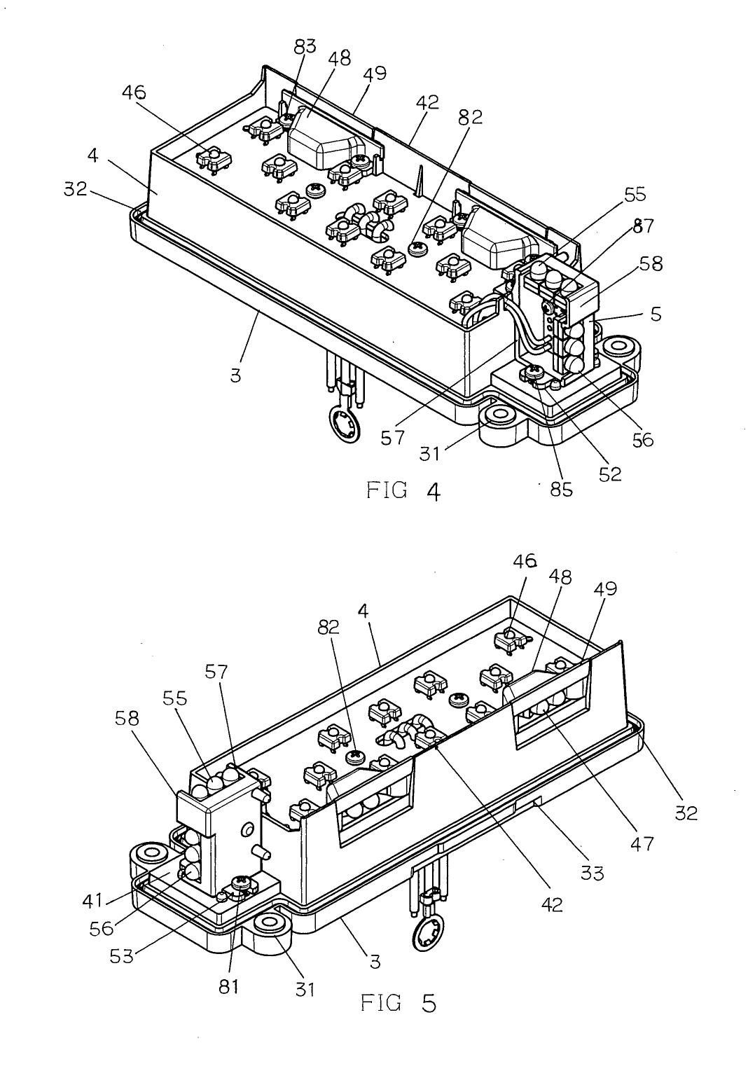

The main light base 3, as shown in FIGS. 1, 4 and 5, is an opaque plastic body, having two ears 31 each with a hole at a right side facing threaded holes 71 of the bottom base 1 for a screws 81 to pass through and engage threaded holes 71. Further, the main light base 3 has a case body 4, and an extended fix base 41 at the right side of case body 4 between the two ears 31. The fix base 41 has two threaded holes 72, 73, and the case body 4 has two threaded holes 74 spaced apart in the center portion, plural threaded holes 75 properly around the threaded holes 74, a separating plate 42 with two openings 43 positioned at a rear side of the case body 4, a position post 44 at an inner wall of the case body 4, and a first electric circuit board 45 positioned in the case body 4. Then a main light set 46 and a license plate light set 47 respectively consisting of plural LED lamps are connected with the first electric circuit board 45, which is kept stably fixed with the case body 4 by means of screws 82 engaging the threaded holes 74, with wires passing through holes 11 of the bottom base 1 and connecting the first electric circuit board 45 with an electric system of an automobile.

The main light set 46 faces the main light cap 2, the license plate light set 47 faces the license plate light cap 24 and is closed by two lamp covers 48 with a triangle shade and an opening. Each lamp cover 48 has a upper edge 49 on the opening conforming to the opening 43 of the separating plate 42, with the upper edge 49 being in line with and flush with the separating plate 42 and fixed with screws 83 passing through the lamp cover 48 and the first electric circuit board and then engaging the threaded holes 75, for separating the beam of the license plate light set 47 from that of the main light set 46. The main light base 3 can be filled with waterproof glue through the rear wall into the case body 4 for sealing the first electric circuit board 45, all the LED lamps of the main light set 46 and the license plate light set 47 and the lamp cover 48 as integral. Further, between the outer circumference of the case body 4, the fix base 41 and the ears 31 is provided with a surrounding groove 32, and a notch 33 under the surrounding groove 32 for pressing the press strip 27 of the license plate light cap 24 in place as shown in FIG. 9.

The side light base 5, as shown in FIG. 1, 4, 5 and 7, is an opaque plastic body, positioned on the fix base 41 of the case body 40, having a first hook 51 on an inner wall facing to the side wall of the case body 4, a second hook 52 and a third hook 53 formed in the upper section and the lower section of a rear wall. Then a screw 83 pass through the first hook 51 to engage with the position post 44 of the case body 4, and two screws 85 and 86 pass through the second hook 52 and the third hook 53 to engage the two threaded holes 72 and 73 of the fix base 41 for connecting the side light base 5 with the front side of the fix base 41 beside the case body 4. The side light base 5 further has a threaded hole 76, and contains a second electric circuit board 54, a car width indicating light set 55 consisting of plural LED lamps, and the side indicating light set 56. The car width indicating light set 55 and the side indicating light set 56 are traditionally connected with the second electric circuit board 54, which is then connected with the first electric circuit board 45 with wires and fixed stably by screws 87 passing through the circuit board 54 and engaging the threaded holes 76. The car width indicating light set 55 faces the width indicating light cap 21 of the main light cap 2, and the side indicating light set 56 faces the side light cap 23. The side light base 5 has a separating plate 57 formed in an inner side of the case body 4 for separating the car width indicating light set 55, the side indicting light set 56 from the main light set 46, and an outer separating plate 58 formed at an outer side for separating the car width indicating light set 55 from the side indicating light set 56. Then waterproof glue is poured into the side light base 5 to seal the second electric circuit board 54, the whole LED lamps of the car width indicating light set 55 and the side indicating light set 56 together as integral.

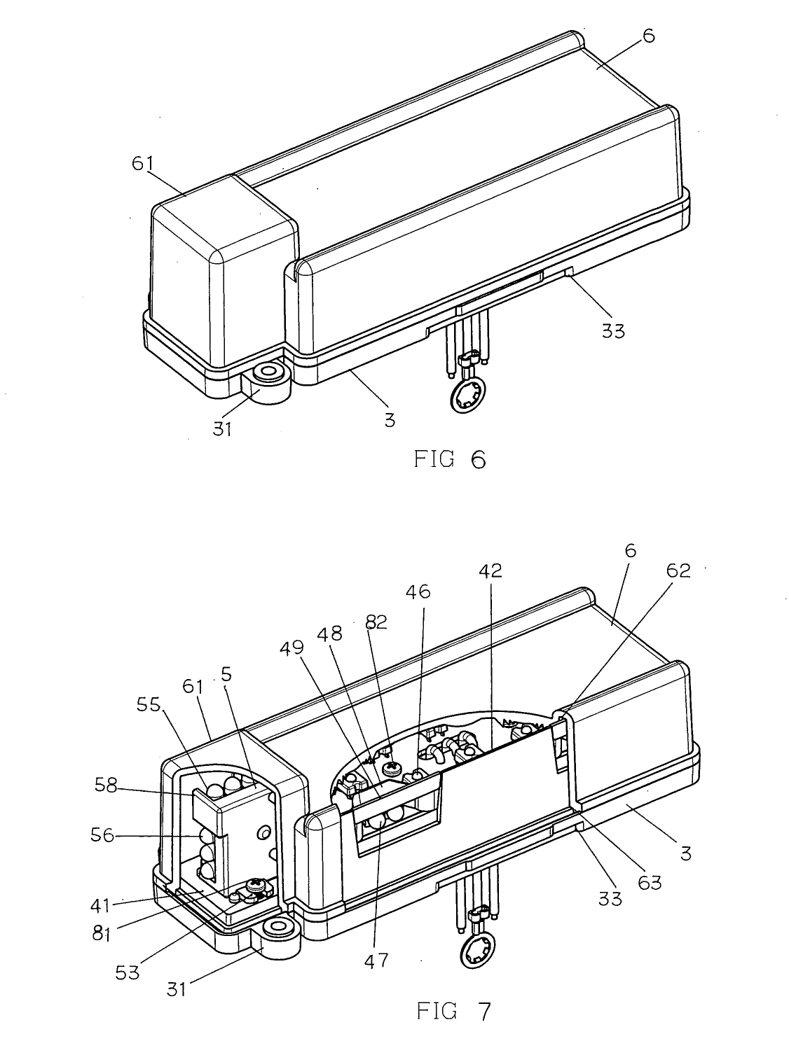

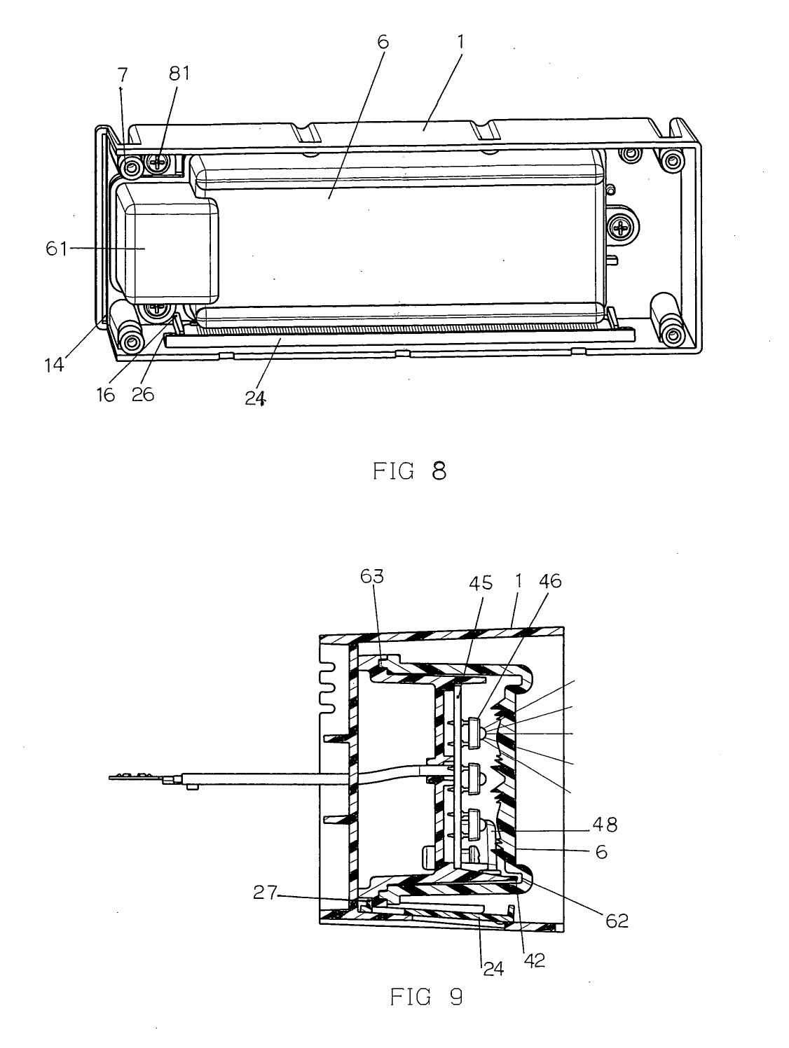

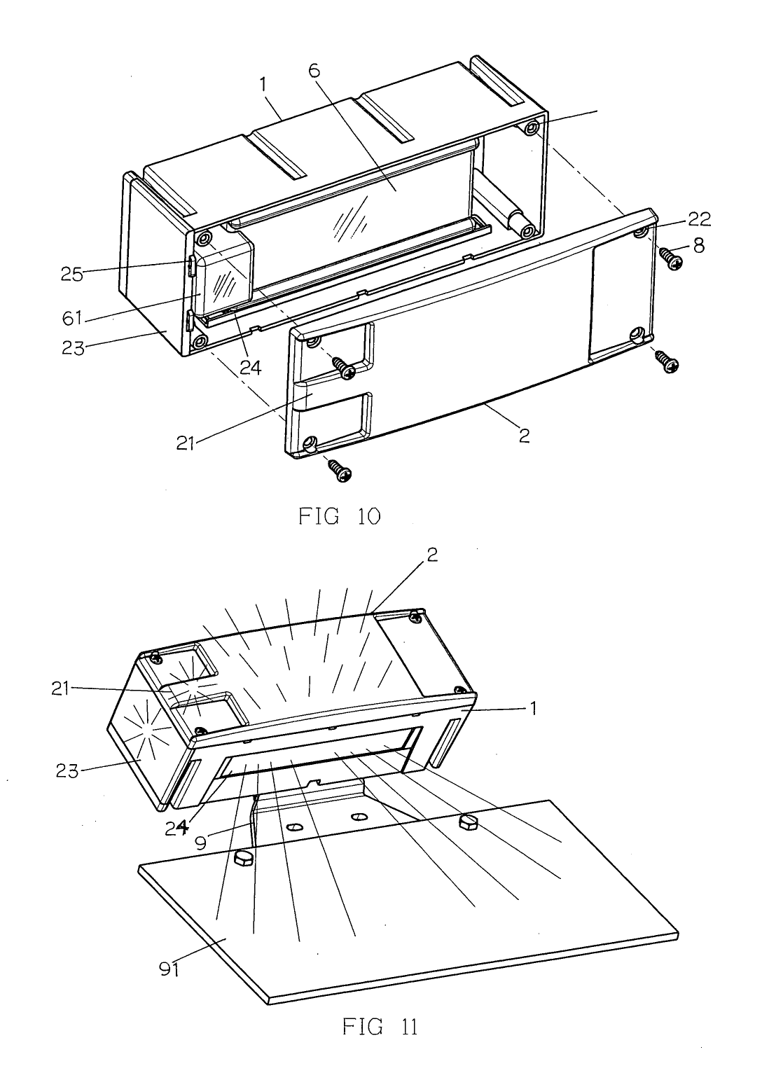

The sealing cap 6, as shown in FIGS. 1, 6 and 10, is a transparent case-like shape, closing on the case body 4 of the main light base 3, having an extended portion 61 to cover around the side light base 5, and a position groove 62 formed in an upper inner wall to fit with the upper edge 49 of the lamp cover 48 to align with the separating plate 42 of the case body 4. Further, a fitting tenon 63 is formed around the sealing cap 6 together with the open end of the extending portion 61 to fit with the fitting groove 32 of the main light base 3, and then sealed by welding process with a supersonic wave machine.

While the preferred embodiment of the invention has been described above, it will be recognized and understood that various modifications may be made therein and the appended claims are intended to cover all such modifications that may fall within the spirit and scope of the invention.

1. An automobile compound waterproof tail light comprising:
a bottom base being of an opaque case-like shape, having its front side closed up by a main light cap, a left side closed up by a side light cap, a center opening formed in a bottom wall and closed up by a license plate light cap, and a car width indicating light cap positioned beside said main light cap;
a main light base being opaque, having a case body and a fix base extending from said case body, a first electric circuit board, a main light set consisting of plural LED lamps and a license plate light set fixed in said case body, said main light set and said license plate light set connected with said first electric circuit board that is connected with an electric system of an automobile, said main light set facing said main light cap, a separate plate provided in an rear wall and having two openings, said license plate light set facing said license plate light set through said openings of said separate plate, waterproof glue poured into said case body for sealing together said first electric circuit board, all the LED lamps of said main light set and said license plate light set as integral;
a side light base being opaque, fixed beside said case body and at a front side of said fix base, a second electric circuit board and a car width indicating light set and a side indicating light set both consisting of plural LED lamps fixed in said side light base, said car with indicating light set and said side indication light set both connected with said second electric circuit board that is also connected with said first electric circuit board with wires, said car width indicating light set facing said car width indicating light cap of said main light cap, said side indicating light set facing said side light cap, a separating plate provided at an inner wall of said side light base along said case body, an outer separating plate provided at an outer wall of said side light base, waterproof glue poured in said side light base for sealing said second electric circuit board and all the LED lamps of said car width indicating light set and said side indicating light set as integral; and,
a sealing cap being transparent, closing on said case body of said main light base and said fix base and sealed in said bottom base by welding process with a supersonic wave machine.

2. The automobile compound waterproof tail light as claimed in claim 1, wherein said bottom base has a plurality of threaded holes spaced apart regularly, and said main light case has holes corresponding to said threaded holes of said bottom base, and screws pass in said holes and screw with said threaded holes for combining said main light cap with said bottom base.

3. The automobile compound waterproof tail light as claimed in claim 1, wherein said side light cap is vertical to said main light cap, and said license plate cap is vertical to said main light cap and said side light cap.

4. The automobile compound waterproof tail light as claimed in claim 1, wherein said license plate light set of said main light base is covered with a lamp cover with a triangle shade and an opening, and said lamp cover has an upper edge at the front side, and the opening of said lamp cover faces the openings of said separating plate, and the upper edge aligns to and is plush with said separating plate.

5. The automobile compound waterproof tail light as claimed in claim 1, wherein said sealing cap has a position groove in an inner lower portion, and a separating plate is fitted in the position groove and aligns to said separating plate of said case body and said upper edge of said lamp cover.

6. The automobile compound waterproof tail light as claimed in claim 1, wherein a circumferential groove is formed around said case body of said main light base together with said fix base and said ears, and a circumferential tenon is formed around the opening of said sealing cap to fit with said circumferential groove.

7. The automobile compound waterproof tail light as claimed in claim 1, wherein said bottom base has plural threaded holes in a rear wall, and said main light base has plural ears with a hole corresponding to said threaded holes for screws to pass through and engage for combining said main light base with said bottom base.

8. The automobile compound waterproof tail light as claimed in claim 1, wherein said license plate light cap has a press strip extending up from an inner side, said main light base has a groove under said fitting groove for pressing said press strip in place.

9. The automobile compound waterproof tail light as claimed in claim 1, wherein said side light base has a first hook with a notch facing said case body of said main light base, said case body has a position post at the inner wall, and said first hook fits with said position post and fixed stably with a screw.

10. The automobile compound waterproof tail light as claimed in claim 1, wherein said side light base has a second hook with a notch and a third hook with a notch respectively on an upper and a lower portion of the rear wall, said main light base has two threaded holes in a front side, and said second and said third hook align to said two threaded holes for screws to engage with.

11. The automobile compound waterproof tail light as claimed in claim 1, wherein said case body of said main light base has two threaded holes for screws to pass through said first electric circuit board and engage with said threaded holes.

12. The automobile compound waterproof tail light as claimed in claim 1, wherein said main light base has plural threaded holes in a lower wall for screws to pass through said lamp cover and engage with said threaded holes.
